(19) United States
(12) Patent Application Publication
(10) Pub. No.: US 2024/0262599 A1
(43) Pub. Date: Aug. 8, 2024

(54) NESTED HEAT-SEALABLE BAGS FOR FOOD STORAGE

(71) Applicant: William Cho, Reno, NV (US)

(72) Inventor: William Cho, Reno, NV (US)

(21) Appl. No.: 18/434,541

(22) Filed: Feb. 6, 2024

Related U.S. Application Data
(60) Provisional application No. 63/443,638, filed on Feb. 6, 2023.

(51) Int. Cl. B65D 81/32; B65B 25/00; B65B 29/10; B65B 51/10; B65D 81/20

(52) U.S. Cl. CPC B65D 81/3272; B65B 25/001; B65B 29/10; B65B 51/10; B65D 81/2023

(57) ABSTRACT

A storage bag for particular use with home based vacuum heat sealing devices includes nested bags. An outer bag may store substantially dry foodstuffs such as meat, and/or crunchy items. A smaller bag, pouch or sachet may store a liquid marinade, sauce or similar flavoring. The smaller bag may be sealed and then sealed within the outer bag which be vacuum sealed. Channels may be embossed into the bag layers of the outer bag to facilitate evacuation of the outer bag by the vacuum sealing device prior to heat sealing. The smaller inner bag may include a frangible outer seam that can be manipulated through the outer bag to cause the seam to rupture, thereby allowing the contents of the inner bag to mix with the contents of the outer bag, e.g. to cause a meat product to marinate prior to consumption.

### CROSS REFERENCE TO RELATED APPLICATIONS

This application claims priority to U.S. Provisional Application Ser. No. 63/443638 filed 6 Feb. 2023, the entire contents of which are incorporated herein by reference.

### FIELD OF THE INVENTION

The present invention relates to multi-compartment sealable bags.

### BACKGROUND

The problem with household vacuum sealers is when drawing vacuum on a bag containing liquid marinade and food, the liquid marinade will be drawn out along with the air inside the bag. However, generally, it is only the meat component (or solid food component) of the mixture that is required to be vacuum sealed for preservation.

What is required is an improved heat sealable household bag that can store both vacuum sealed ingredients and non-vacuum sealed ingredients.

### SUMMARY OF ONE EMBODIMENT OF THE INVENTION

### Advantages of One or More Embodiments of the Present Invention

The various embodiments of the present invention may, but do not necessarily, achieve one or more of the following advantages:
allow merging of contents without opening the bag;
allow sealing of multiple bags in a single sealing operation;
allow dry foods to be stored separately from wet foods while allowing mixing at the time of consumption.

These and other advantages may be realized by reference to the remaining portions of the specification, claims, and abstract.

### Brief Description of One or More Embodiments of the Present Invention

A storage bag for particular use with home based vacuum heat sealing devices includes nested bags. An outer bag may store substantially dry foodstuffs such as meat, and/or crunchy items. A smaller bag, pouch or sachet may store a liquid marinade, sauce or similar flavoring. The smaller bag may be sealed and then sealed within the outer bag which be vacuum sealed. Channels may be embossed into the bag layers of the outer bag to facilitate evacuation of the outer bag by the vacuum sealing device prior to heat sealing. The smaller inner bag may include a frangible outer seam that can be manipulated through the outer bag to cause the seam to rupture, thereby allowing the contents of the inner bag to mix with the contents of the outer bag, e.g. to cause a meat product to marinate prior to consumption.

In one embodiment, there is provided a heat sealable bag system for food storage. The system comprises a first bag comprising a first opening on a first edge for receiving a first material into the first bag and a second bag receivable into the first bag. The second bag may comprise a second opening on a second edge for receiving a second material into the second bag and an at least partially frangible outer seam. The outer seam can be manipulated to rupture a frangible portion of the frangible outer seam while the second bag is sealed within the first bag to allow mixing of the first material and the second material within the first bag.

In one embodiment, there is provided a method for storing foodstuffs within a heat-sealable bag. The method may comprise providing a first foodstuff into a first opening of a first bag and providing a second foodstuff into a second opening of a second bag. The second bag may comprise an at least partially frangible outer seam. The second opening may be heat sealed and the first opening may be heat sealed either in a the same operation or in a separate operation, to heat seal the first opening with the first foodstuff and the sealed second bag inside the first bag.

In one embodiment, there is provided bag for use as an inner liquid food bag of a food storage system. The bag is configured to be received within an outer bag that is subsequently vacuum sealed. The bag may comprise a plurality of edge seams that define a perimeter of the bag and an internal volume of the bag. One or more of the plurality of edge seams may comprise a frangible portion. The bag may have an opening for filling the internal volume with a liquid foodstuff. The frangible portion may be configured to be ruptured by manipulation of the bag once the bag has been heat sealed and disposed within a sealed outer bag containing a dry food product.

In one embodiment, there is provided a method for food storage using a food storage bag. A first foodstuff may be placed into a first opening of a food storage bag and a sealed rupturable liquid flavor sachet may be placed into the food storage bag. The food storage bag may then be vacuum sealed and stored. At a later time, e.g. at a time of consumption, the liquid flavor sachet may be ruptured without opening the bag to allow the contents of the liquid flavor sachet to mix with the first foodstuff.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 substantially depicts an embodiment of an outer bag of a multi-bag system for storing foodstuffs;

FIG. 2 substantially depicts an embodiment of an inner bag for use insider the outer bag, the inner bag containing a partially frangible outer seam;

FIG. 3 substantially depicts a frangible seal featuring voids as areas of reduced seal strength; and

FIG. 4 substantially depicts a multi-bag system wherein an inner bag is co-formed with the outer bag;

FIG. 5 substantially depicts an inner surface of a layer for an outer bag with an embossed portion adjacent the opening;

FIG. 6 substantially depicts an inner surface of a layer for an outer bag with an embossed portion extending throughout the first compartment;

FIG. 7 substantially depicts an outer bag having a one-way valve for evacuating the outer bag;

FIG. 8 substantially depicts a method for using the multi-bag system for storing mixable foodstuffs; and

FIG. 9 substantially depicts a method for using sealed flavor sachets in a food storage bag;

FIG. 10 substantially depicts a filling step for filling a food storage bag with a food product;

FIG. 11 substantially depicts a step of adding a flavor sachet;

FIG. 12 substantially depicts a step of sealing the food storage bag;

FIG. 13 substantially depicts a step of rupturing the flavor sachet within the food storage bag and mixing the contents throughout the food storage bag; and

FIG. 14 substantially depicts a step of opening the food storage bag to remove the mixed contents.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present inventors have realized that household food storage systems do not necessarily require all ingredients of a mixture to be vacuum sealed. Generally, meat or other solid foodstuffs require vacuum sealing so that bacteria and similar within the foodstuff cannot multiply and lead to spoilage. Other foodstuffs, particularly liquid marinades and the like, may have preservatives (natural or added) and may have been cooked or mixed in a way that naturally kills most of the bacteria that could lead to spoilage. However, it is difficult to vacuum seal marinated meats and the like using conventional household vacuum sealings systems and bags because the liquid component can be extracted into the sealing area of the bag, effecting the quality of the seal and also potentially causing damage or contamination within the vacuum sealing apparatus.

Furthermore, the present inventors have realized that meats do not require marinading for their entire shelf life, but may be combined closer to the time of consumption, typically within approximately 24 hours. However, there is currently no household heat sealable bag available that allows different food components to be stored separately and later combined.

Further still, if dried or semi-dried meats are used in combination with vacuum sealing, it may be possible to extend the shelf life even longer.

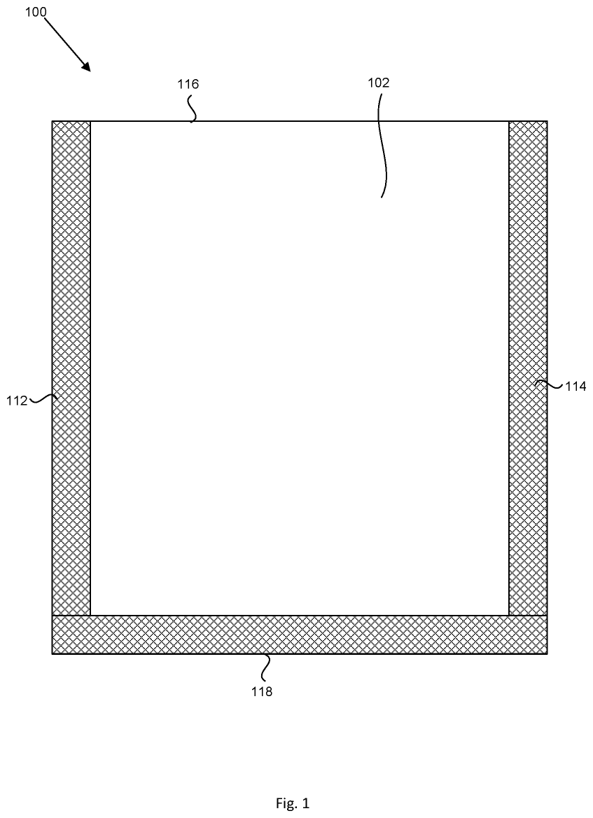

With these realizations in mind, there will be described herein a two pouch vacuum sealable bag for food storage that allows separation of different foodstuffs, particular wet and dry ingredients, and later mixture of the ingredients within the bag. FIG. 1 shows a first bag or pouch 100 of multi-bag system for food storage. The first bag 100 is intended as an outer bag. The first bag 100 may be formed by overlaying two layers of plastic film. Each layer may itself, be comprised of multiple laminations or layers, as is known in the art. Strong (i.e. non-frangible) side seals 112, 114 may be formed by heat sealing down each side edge of the bag 100. A strong bottom edge seal 118 may be formed in the same manner The bag may include an open edge 116 through which material may be added to an internal compartment or volume 102 defined by the edges 112, 114, 116, 118 of the bag 100. The open edge 116 may be heat sealed using a heat vacuum sealing device to form a sealed bag having an internal volume 102. The vacuum sealing device may also be used to evacuate air from within the compartment 102 prior to sealing.

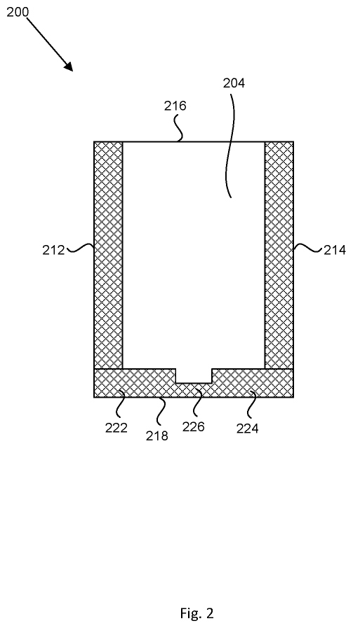

FIG. 2 shows a second bag or pouch 200 of the multi-bag system for food storage. The second bag 100 is intended as an inner bag of the multi-bag system and is designed to be received within the first bag 100. Accordingly, the second bag 200 is smaller than the first bag 100. The second bag may be intended to store liquid food material, such as a marinade, sauce, or similar flavoring. The second bag 200 may be formed by overlaying two layers of plastic film. Each layer may itself, be comprised of multiple laminations or layers, as is known in the art. The second bag 200 may include two strong edge seals, e.g. side seals 212, 214. The bottom edge seal 218 may be a frangible seal. The frangible edge seal 218 may include fully sealed strong seal portions 222, 224 and an intermediate frangible seal portion 226 between the strong seal portions 222, 224. While the frangible seal is shown in the lower edge 218 of the bag, the frangible seal may be located in any edge of the second bag 200.

The bag 200 may include an open edge 216 through which material may be added to an internal compartment or volume 204 defined by the edges 212, 214, 216, 218 of the bag 200. The open edge 216 may be heat sealed using a heat vacuum sealing device to form a sealed bag having an internal volume 204.

Each bag 100, 200 may be filled with a material by the user and then heat sealed using any of a known variety of bag sealing systems. The bag sealing system may further incorporate vacuum elements for vacuum sealing one or both of the compartments.

The bags 100, 200 will, by necessity, be of different sizes so that the second bag nested within the first bag as will be described below. The relative sizes of the bags may be dependent on an intended use of the bag and thus each bag may be labelled with that use.

The user may provide different food materials into each of the bags 100, 200, seal the second bag 200, e.g. by placing the open end 216 of the bag 200 into a vacuum sealing device and operating the device in a heat-seal only mode. The sealed second bag 200 may then be placed into the first bag 100 before sealing the first bag, e.g. by placing the open end 116 of the first bag into the vacuum sealing device. One or both of the bags 100, 200 may have a vacuum applied to vacuum seal the respective bag.

In one embodiment, the multi-bag system may be utilized to store foodstuffs. For example, a meat product may be stored in the outer bag 100 and a marinade for the meat product may be stored in the inner bag 200. The marinade may be filled through the opening 216 and sealed shut with minimal amount of air bubbles. The outer bag 100 filled with the meat or food product that is to be marinaded and the sealed marinade pouch 200 may be vacuum heat sealed for long preservation and shelf life. When the user desires to use the product, the user may break the frangible seal 218 to allow that marinade to leak into the outer bag 100 to thereby mix with the meat product.

In an alternative example, the outer bag 100 may be filled with a dry product, in particular a crunchy product while the inner bag 200 may be filled with a wet product. The compartments may be combined just prior to serving by breaking the frangible seal, thereby allowing the food product to remain crunchy up to the time of consumption.

The bags 100, 200 may be configured for use with a vacuum sealing machine such as the range of FoodSaver™ machines provided by Newell Brands™. These machines typically include a heat sealing bar that when pressed down upon the open end of a plastic bag will heat seal the two layers of the bag to each other. The machines can typically be operated in a heat sealing only mode, a vacuum mode only or a combined vacuum and heat sealing mode.

The frangible seal 218 may be formed in a variety of ways. In one embodiment, the frangible seal may be made by printing an adhesive on to the inner surface of the film during manufacturing. The pattern and density of printed adhesive determines how strong the seal is. The printing could be done with a dot matrix printer, wheel, screen (like a silk screen), spray, etc.

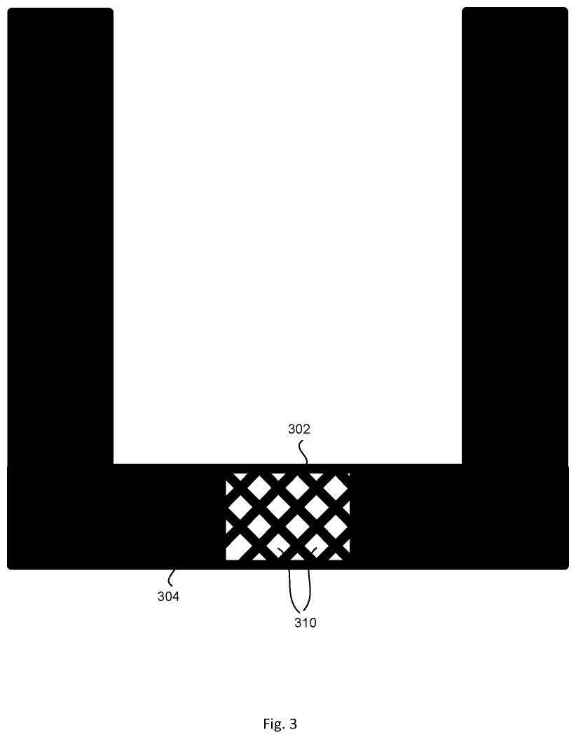

In one embodiment, the frangible seal may be formed by creating voids in the standard strong heat seal. As shown in FIG. 3, voids 310 formed in the seal reduce the sealed strength in the void section 302 relative to the non-void section 304 and dictate where the break is to occur. This method can be controlled to have a certain percentage of void for the desired frangible characteristic. For instance, 25% void area of seal would be stronger than 80% void area of seal.

In one embodiment, the frangible seal may be formed using high and low areas in a seal bar. Higher points on the seal bar would create stronger seal while the lower points on the seal bar would create weaker seal, thereby producing a frangible characteristic. By varying the pattern, depth of highs and lows, percentage of high areas and shapes of the high areas different frangible characteristics can be created.

In one embodiment, the frangible seal is made by using different sealing parameters than the non-frangible seals. The parameters may include temperature, pressure and exposure time. For example, a seal bar with a lower temperature is applied to the frangible area with less pressure and time than is applied to the non-frangible areas (edge seams) or strong seal portions of the compartment seals.

In one embodiment, the plastic film may include a layer of weaker material for the frangible seal. Specifically, a polybutene material may be used. In one specific embodiment, polybutene/polyester or any two or more blends of polyolefin may be used to create a peelable film.

Because the frangible bag 200 is located, in use, within the outer bag, the frangible seam is configured to be broken by manipulation through the outer bag. In particular, the strength of the frangible seam is designed so that the frangible seam may be broken by manipulation through the outer bag. In one embodiment, the manipulation may be performed by the user by squeezing the frangible bag to increase the liquid pressure within the inner bag 200 until the frangible seam ruptures. In one embodiment, the manipulation may be performed by the user feeling for the walls of the inner bag through the outer bag and then forcing the walls of the inner bag apart until the frangible seam ruptures. This latter method may be more difficult than the squeezing method and made more difficult if the outer bag has been vacuum sealed.

In the embodiment depicted by FIGS. 1 and 2, the outer bag 100 and inner bag 200 are independent bags that can be filled and sealed independently. That is, the user may fill the smaller inner bag 200 with a liquid product and heat seal the inner bag 200 using a vacuum sealing device in heat sealing only mode. The user may then fill the outer bag 100 with a dry product, insert the filled and sealed inner bag 200, and then heat seal the outer bag, with optional evacuation of the air of the outer bag using the vacuum sealing function of the vacuum sealing device. In this configuration, the inner bag is received freely into the outer bag and is able to move around within the volume of the outer bag.

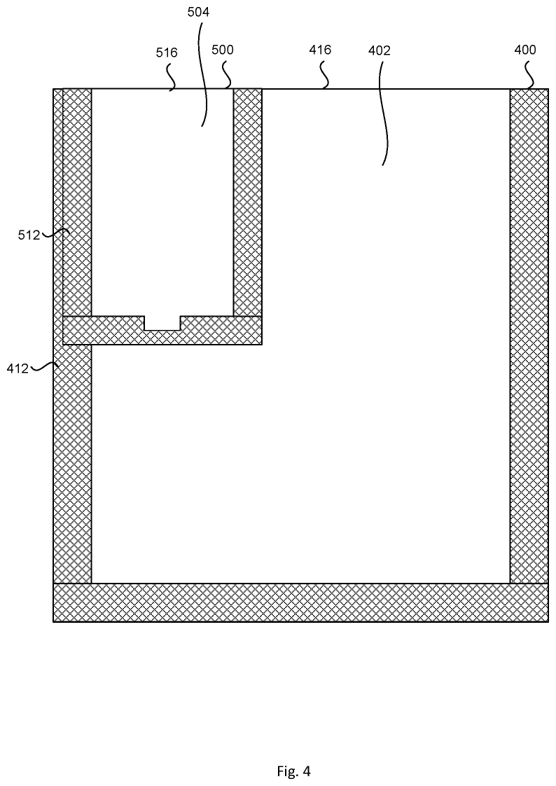

FIG. 4 depicts an alternative embodiment in which an outer bag 400 is co-formed with an inner bag 500. In this embodiment, the inner bag 500 may be manufactured as previously described with an open edge 516, side seams 512, 514 and a frangible seam 518. The unsealed bag may then be located on top of a first layer of the outer bag 400 with one edge seam, e.g. seam 512 in alignment with the edge seam 412 of outer bag 400 and with the open edge 516 in alignment with the open edge 416 of the outer bag 400. The upper layer of the bag 400 may then be places over the lower layer and the inner bag 500 and the seams 512, 514 and 518 may be formed through heat sealing and/or adhesive processes as is known in the art. By virtue of the edge seam 512 being pressed and retained between the layers that form edge seam 412, the inner pouch 500 is held secure to the outer bag 400.

An advantage of the embodiment of FIG. 4 is that the sealing of both bags 400, 500 can be performed in a single operation. A further advantage is that the inner pouch is fully retained by the outer pouch. Thus, when the contents of the two bags have been mixed, the mixed contents can be removed from the outer bag, e.g. poured out while the inner pouch remains within the outer bag.

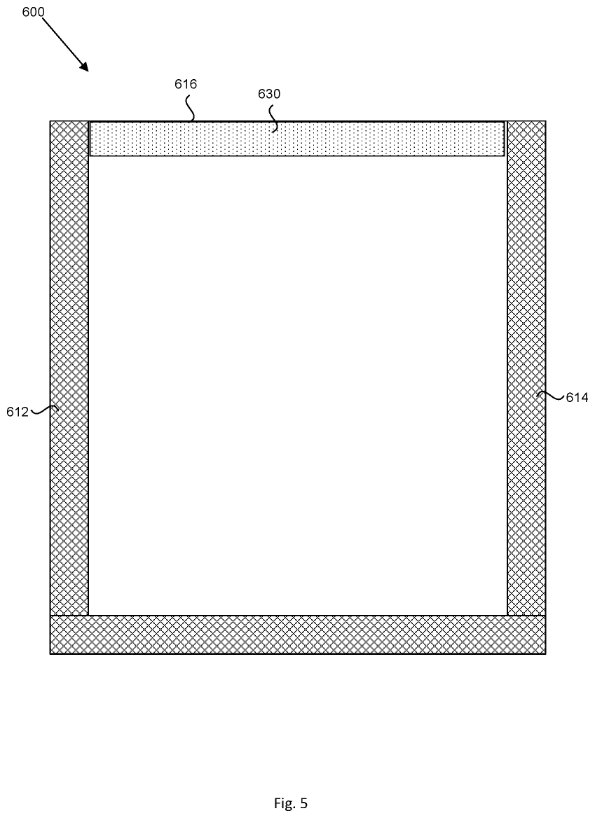

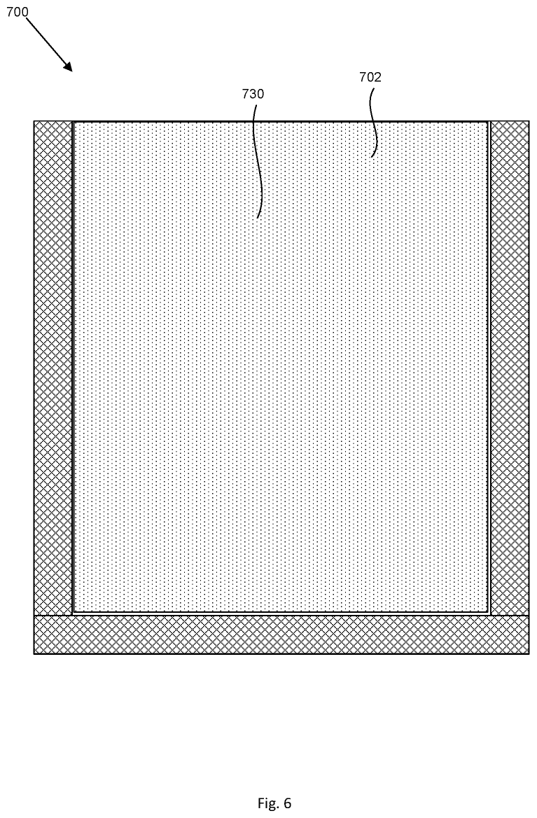

A particular example described above is to include relatively dry, solid, or particulate material into the outer bag and to provide a wet material into the inner bag. The bags may be specifically designed and labelled for this purpose. In one embodiment, the inner surfaces of the open edge of the outer bag may be embossed with one or more grooves that facilitates vacuum sealing of this edge. However, the inner surfaces of the inner bag may remain unembossed as such grooves can cause liquid to be drawn out of the bag and into the vacuum sealing machinery during vacuum sealing. The liquid can also be caught in the seal area and adversely affect the sealing operation. By maintaining the inner surfaces of the inner bag as smooth, these surfaces will block off at the opening when a vacuum is applied at the opening, thereby preventing any evacuation of the inner bag. FIG. 5 shows the inner surface of one layer of an outer bag of a multi-bag system in accordance with an embodiment of the present invention. The portion of the layer 600 for the outer bag (dry bag) 602 includes an embossed section 630 extending between the side edges 612, 614 adjacent the open edge 616. The embossing may be formed by a roller, or other suitable means apparent to the person skilled in the art. The embossing may be formed on each of the overlying layers that form the bag or on a single layer only. The inner bag, intended for liquid product, does not include or require any embossing at its opening. FIG. 6 shows an embodiment where the embossing 730 on the inner layer has been provided throughout the entire volume 702 of the outer bag 700.

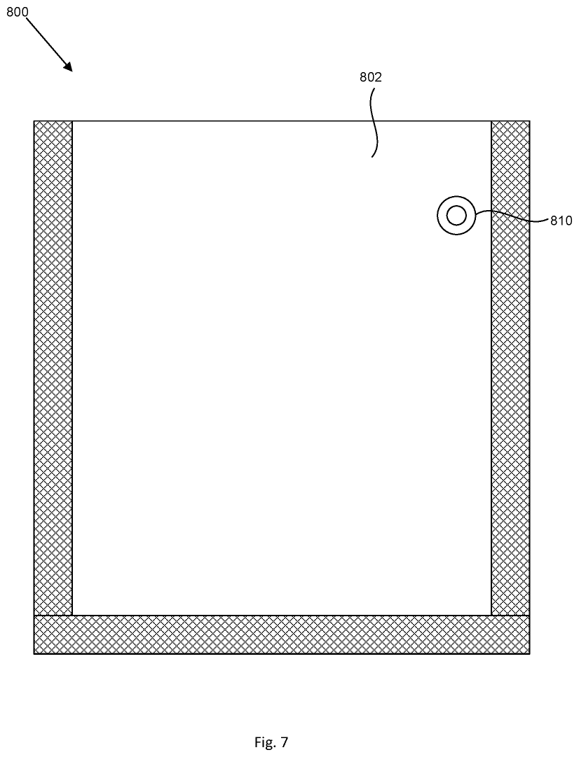

FIG. 7 shows an embodiment of a bag 800 featuring a one-way valve 810 in the outer bag 800 that access the volume 802 of the bag 800 to evacuate the contents of the volume 802. The one way valve 810 may be configured for use with certain types of vacuum sealing machines. The inner bag (hidden in FIG. 7), not intended for vacuum sealing, does not require a one-way valve.

While a two bag system is shown, the person skilled in the art will recognize that a greater number of inner bags with frangible seals may be provided within the outer bag. Such multiple bags could allows for staged marination and addition of ingredients.

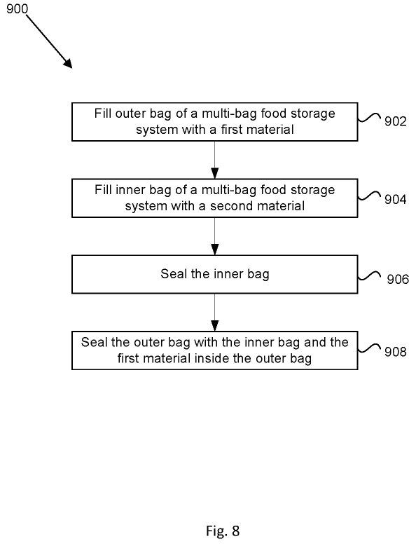

A method 900 for using the multi-compartment bag is illustrated in FIG. 8. At step 902, a first material is added to an outer bag of a multi-bag food storage system. A second material is added to an inner bag of a multi-bag food storage system (step 904). The inner bag may be sealed at step 906 and at step 908 the outer bag may be sealed with the first material and the sealed inner bag inside. In one embodiment, e.g. for the independent bags of FIGS. 1 and 2, the method may include filling and sealing the inner bag then adding the sealed inner bag to the outer bag prior to sealing the outer bag. In an alternative embodiment, e.g. where the inner bag is co-formed with the outer bag, the sealing steps 904, 906 may be performed simultaneously. For either embodiment, the method may include the step of evacuating the outer bag prior to sealing the outer bag.

As previously discussed, the inner bag may be used to store a liquid, e.g. a marinade, flavored sauce, etc. while the outer bag may be used to store a product to be marinaded, such as a meat product. Once both bags are sealed, the outer bag containing the inner bag may be stored until required, with refrigeration or freezing if necessary. To access the contents of the bag, the bag may be thawed if frozen until the contents of the liquid compartment 104 are again liquid. The inner bag may be manipulated through the outer bag to break the frangible seam 218. For example, the two layers of the bag may be pulled apart in the region of the seam 218 to break the frangible portion 226 of the seam. Alternatively, the inner bag may be squeezed until the pressure forces the frangible seal 218 to rupture. Once the frangible seam is broken, any vacuum in the outer bag 100 will draw liquid from the inner bag as the two compartments equalize. The bag may be shaken or otherwise manipulated to mix the contents of the two compartments. Once sufficient mixing has been achieved and, optionally, sufficient marination time has elapsed, the user may open one or more of the outer edges 112, 114, 116, 118 of the outer bag 100 to access the mixed contents within. One or more of the outer edges may be provided with a destructive peel seal or a tearable edge, as is known in the art, to facilitate opening of the outer bag.

In one embodiment, the inner bags may be provided as sealed sachets containing a particular liquid foodstuff. In one embodiment, the liquid may be marinade intended to be added to a raw meat package. At the time of consumption, the marinade sachet can be ruptured within the meat package to marinate the meat prior to cooking. Alternatively, the liquid may be a sauce intended to be added to a cooked meat or similar. At the time of consumption, the sauce sachet can be ruptured to flavour the contents of the outer food package which may then be eaten raw, re-heated or cooked further.

The flavoring sachets may be sold as kits with multiple flavors in a single kit. Alternatively, a user may make their own flavor sachets, including creating their own liquid flavorings, by adding a liquid flavoring to an unsealed rupturable sachet, heat sealing the sachet using a vacuum sealing device, and then adding the sealed sachet to the food storage bag prior to vacuum sealing.

The use of a sealed but rupturable flavor sachet allows a liquid flavoring to be incorporated into a food storage bag while still allowing vacuum sealing of the food storage bag without drawing liquids into the vacuum sealing device.

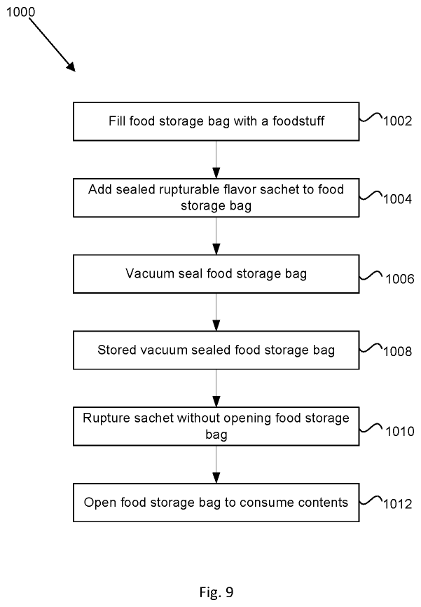

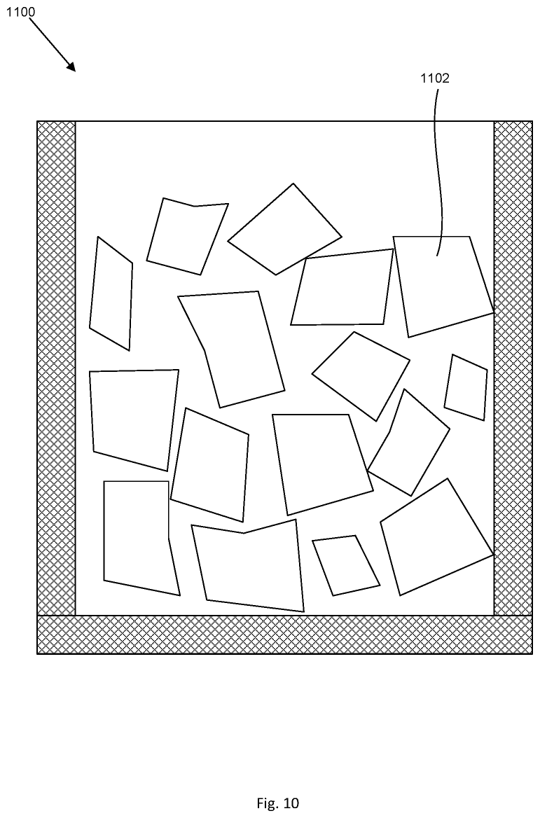

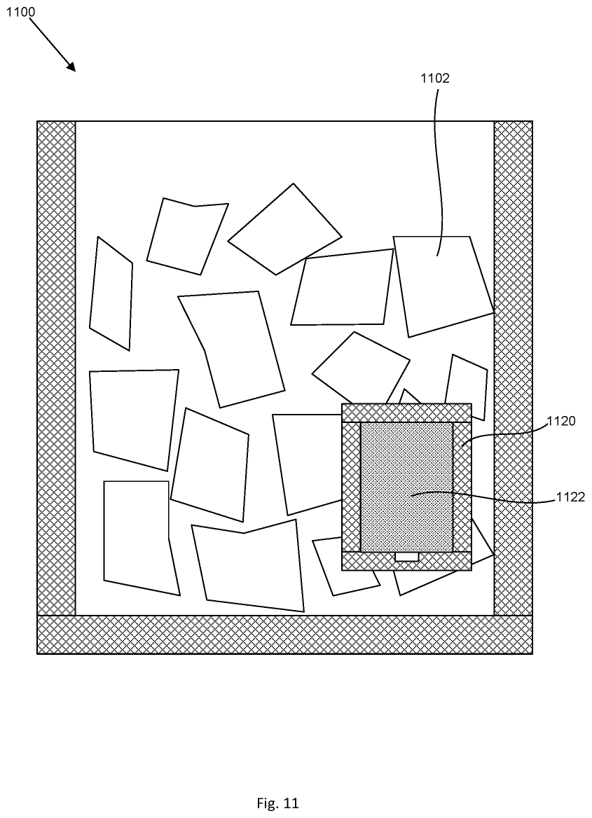

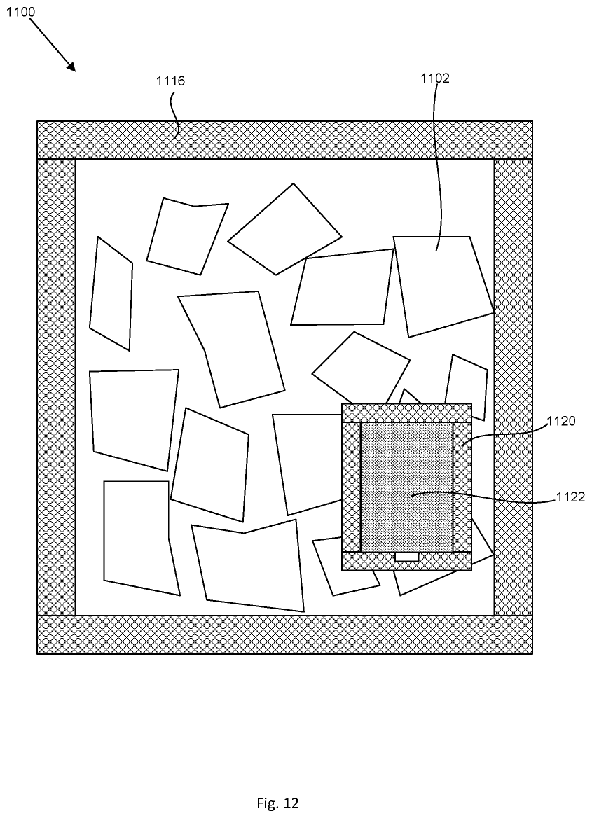

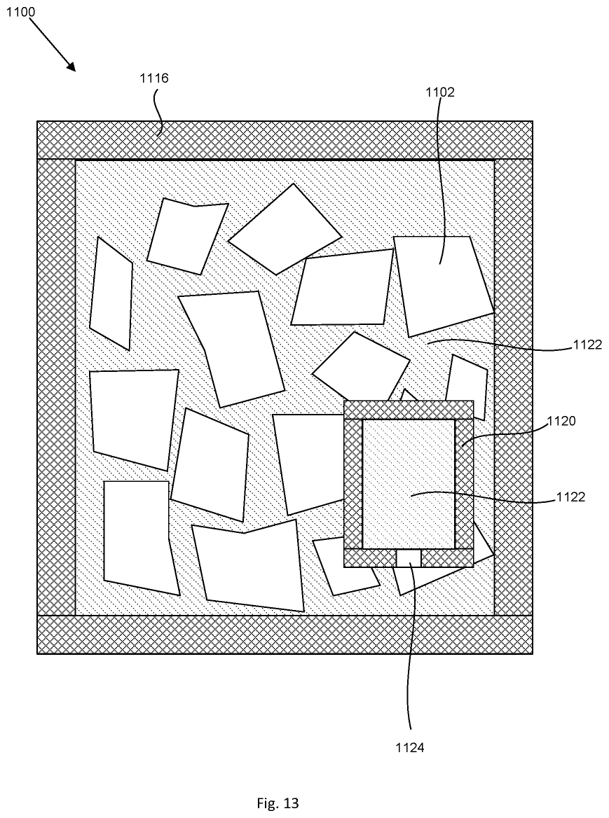

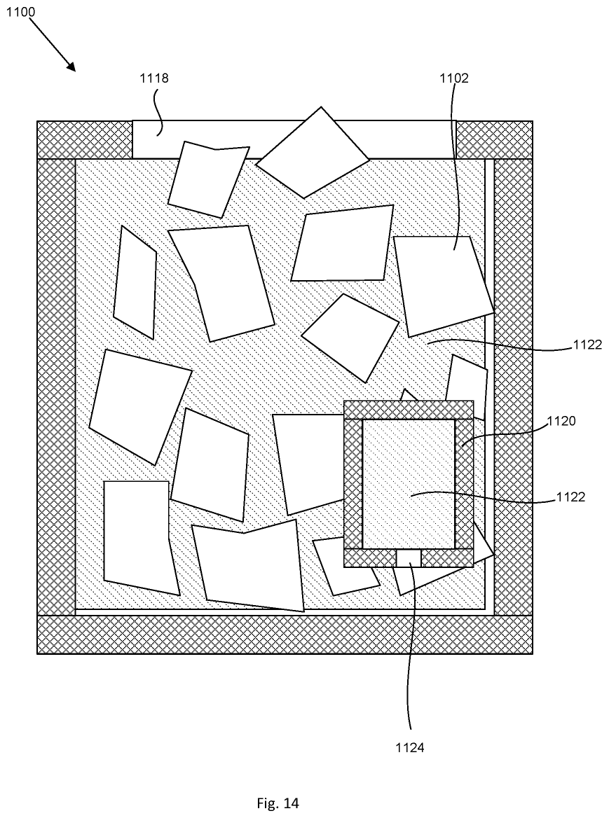

An additional method for food storage is depicted in the flowchart 1000 of FIG. 9. At step 1002, a food storage bag is filled with a first foodstuff, such as a meat product (raw or cooked), crunchy product, vegetables or mixture (e.g. meat and vegetables). FIG. 10 shows a bag 1100 filled a diced meat product 1102, e.g. diced steak. At step 1004, a sealed rupturable liquid flavor sachet 1120 containing a liquid flavoring 1122 such as a marinade is added to the food storage bag 1100 (FIG. 11) and then the food storage bag 1100 is vacuum sealed 1116 (FIG. 12) (step 1006) and stored (step 1008). At a later time, the liquid flavor sachet 1120 is intentionally ruptured 1124 (FIG. 13) (step 1010) without opening the food storage bag to allow the contents 1122 of the liquid flavor sachet to mix with the first foodstuff 1102. At step 1012, the food storage bag can be opened 1118 (FIG. 14) to allow consumption of the mixed contents of the food storage bag, with or without additional food preparation, heating, cooking, etc. as required.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A heat-sealable bag system comprising:
(A) a first bag comprising a first opening on a first edge for receiving a first material into the first bag;
(B) a second bag receivable into the first bag and comprising:
(a) a second opening on a second edge for receiving a second material into the second bag; and
(b) an at least partially frangible outer seam that can be manipulated to rupture a frangible portion of the frangible outer seam while the second bag is sealed within the first bag to allow mixing of the first material and the second material within the first bag.

2. The heat-sealable bag system of claim 1 wherein the second bag is independent of the first bag and is freely received into the first bag.

3. The heat-sealable bag system of claim 1 wherein the second bag is co-formed with the first bag such that an edge seam of the second bag is retained within an edge seam of the first bag and wherein the second opening is aligned with the first opening.

4. The heat-sealable bag system of claim 1 wherein the outer bag is configured for storing a substantially dry product, wherein at least one inner surface of the outer bag comprises an embossed portion that facilitates vacuum sealing of the bag.

5. The heat-sealable bag system of claim 4 wherein the embossed portion is provided at the first opening.

6. The heat-sealable bag system of claim 4 wherein the embossed portion is provided throughout the at least one inner surface of the outer bag.

7. The heat-sealable bag system of claim 4 wherein the second bag does not contain an embossed portion.

8. A method for storing foodstuffs within a heat-sealable bag comprising:
(A) providing a first foodstuff into a first opening of a first bag;
(B) providing a second foodstuff into a second opening of a second bag, the second bag comprising an at least partially frangible outer seam; and
(C) heat sealing the second opening; and
(D) heat sealing the first opening with the first foodstuff and the sealed second bag inside the first bag.

9. The method of claim 8 wherein heat sealing the second opening and heat sealing the first opening are performed as independent sealing operations.

10. The method of claim 8 wherein heat sealing the second opening and heat sealing the first opening are performed in a single operation.

11. The method of claim 8 comprising applying a vacuum to the first opening prior to heat sealing the first opening.

12. The method of claim 11 wherein the first bag comprises an embossed portion that facilitates evacuation of the first bag.

13. The method of claim 11 wherein the second bag is smooth so that applying a vacuum to the second opening closes off the second opening to prevent evacuation of the second bag.

14. The method of claim 8 comprising rupturing the at least partially frangible outer seam and mixing the first foodstuff and the second foodstuff.

15. The method of claim 8 wherein the first foodstuff is a substantially dry foodstuff, the method comprising vacuum sealing the first bag.

16. A bag for use as an inner liquid food bag of a food storage system, the bag configured to be received within an outer bag that is subsequently vacuum sealed, the bag comprising:
(A) a plurality of edge seams that define a perimeter of the bag and an internal volume of the bag, one or more of the plurality of edge seams comprising a frangible portion; and
(B) an opening for filling the internal volume with a liquid foodstuff;
(C) wherein the frangible portion is configured to be ruptured by manipulation of the bag once the bag has been heat sealed and disposed within a sealed outer bag containing a dry food product.

17. The bag of claim 16 wherein the frangible portion is configured to be ruptured by manipulation of the bag once the bag has been heat sealed and disposed within a vacuum sealed outer bag containing a dry food product.

18. The bag of claim 16 wherein the frangible portion is configured to be ruptured by squeezing the bag through the outer bag to increase the liquid pressure within the inner bag until the frangible portion ruptures.

19. The bag of claim 16 wherein at least one of the plurality of seams is configured to be received and retained within an edge seam of the outer bag.

20. A method for food storage comprising:
(A) providing a first foodstuff into a first opening of a food storage bag;
(B) providing a sealed rupturable liquid flavor sachet into the food storage bag;
(C) vacuum sealing the food storage bag;
(D) storing the food storage bag; and
(E) rupturing the liquid flavor sachet without opening the food storage bag to allow mixing of the contents of the liquid flavor sachet and the first foodstuff within the food storage bag.
